(19) United States
(12) Patent Application Publication
(10) Pub. No.: US 2005/0248110 A1
(43) Pub. Date: Nov. 10, 2005

(54) Physical therapy scooter

(76) Inventor: John Stouffer, Marshall, MO (US)

Correspondence Address: HOVEY WILLIAMS LLP, Suite 400, 2405 Grand, Kansas City, MO, 64108, US

(21) Appl. No.: 10/839,414

(22) Filed: May 5, 2004

(51) Int. Cl. B62M 1/00

(52) U.S. Cl. 280/87.021

(57) ABSTRACT

A physical therapy scooter that includes a lower safety skirt extending along side the wheels to prevent the patient's hands from being pinched by the wheels when the scooter is in motion. The scooter can be made of readily available materials and has a relatively simple construction. Thus, the scooter can be produced relatively inexpensively.

### BACKGROUND OF THE INVENTION

1. Field of the Invention

The present invention relates generally to devices for use in physical therapy. In another aspect, the invention concerns a device which provides independent mobility for children who could not otherwise move about on their own.

2. Description of the Prior Art

Many children are born with conditions which hinder strength and/or motor development. One example of such a condition is commonly known as Cerebral Palsy (CP). Although CP affects each child differently, many children born with CP do not automatically develop the strength and/or motor skills necessary to walk, crawl, or even control head movement.

Medical research has shown that the degree of strength and motor development during the first few years of life of a child with CP are critical to the long term physical development of the child. Thus, as soon as a child is diagnosed with CP, most physicians recommend immediate and extensive physical therapy. This physical therapy can take a variety of forms.

One physical therapy method employed for children who can not crawl on their own involves supporting the torso of the child on a wheeled cart in a crawling position so that the child's hands and knees touch the floor. Once the child is in this crawling position, the physical therapist or care giver can then encourage the child to try to use his/her arms and legs to move about on the scooter. This type of therapy can be particularly desirable for a number of reasons. For example, this type of therapy builds strength and coordination in the legs, arms, and hands of the child. Further, the crawling position employed in this method helps strengthen the neck of the child by forcing the child to look up in order to see where he/she is going. In addition, this type of physical therapy can be more enjoyable for the child because for the first time the child can actually move about on his/her own.

Although it is well recognized that this type of supported crawling physical therapy has numerous advantages, many physical therapists and care givers do not use this method because the currently available wheeled carts designed to carry out the therapy are expensive and dangerous. Conventional wheeled carts used for physical therapy have a relatively complex construction, which greatly increases their cost. In fact, conventional wheeled carts used for physical therapy sell for more than two hundred dollars each. However, cost is not necessarily the biggest disadvantage of conventional physical therapy carts. Perhaps the most significant disadvantage of conventional physical therapy carts is that the wheels of the cart are located in a position where they can easily be accessed by the child's hands. Thus, many physical therapists and care givers refuse to use such devices because of the risk that the child's hands or fingers could be pinched under the wheels of the cart while the cart is rolling on the floor.

### OBJECTS AND SUMMARY OF THE INVENTION

It is, therefore, an object of the present invention to provide a physical therapy scooter that is configured to inhibit lateral access to the wheels of the scooter so that the patient's hands can not be pinched by the wheels of the scooter as the patient moves about on the scooter. Another object of the invention is to provide a physical therapy scooter having a relatively simply design that allows the scooter to be easily constructed out of the minimum amount of materials. Still another object of the invention is to provide a physical therapy scooter that can be constructed out of widely available and relatively inexpensive materials. Yet another object of the invention is to provide a safe and effective physical therapy method that can be carried out using a specially designed, relatively inexpensive scooter. It should be noted that the above-listed objects of the present invention are only exemplary. Not all of the above-listed objects need be accomplished by the invention described herein.

One aspect of the present invention concerns a scooter for use in physical therapy. The scooter includes a laterally extending support member, a pair of laterally spaced side members extending upwardly from the support member, a plurality of wheels extending downwardly from the support member, and a safety skirt extending downwardly from the lateral support member. The safety skirt extends alongside at least a portion of the wheels to thereby inhibit external lateral access to the wheels.

Another aspect of the present invention concerns a physical therapy scooter configured to help support and locomote a patient in a crawling position on a floor. The scooter includes a substantially planar, normally-horizontal support member presenting a top surface and a bottom surface, a pair of laterally spaced side members extending upwardly from opposite sides of the support member, a cushion disposed between the side members and on the top surface of the support member, a plurality of caster wheels coupled to and extending downwardly from the bottom surface of the support member; and a safety skirt coupled to the support member and extending below the bottom surface of the support member. The side members extend at least 2 inches above the top surface of the support member. The safety skirt extends alongside and substantially around the caster wheels to thereby inhibit external lateral access to the caster wheels when the scooter is supported by the wheels on the floor.

Still another aspect of the present invention concerns a physical therapy scooter configured to help support and locomote a patient in a crawling position on a floor. The scooter includes the following components: a substantially rectangular, substantially planar support board presenting a top surface, a bottom surface, a left edge, a right edge, a front edge, and a rear edge; a left board coupled to the left edge, extending above the top surface, and extending below the bottom surface; a right side board coupled to the right edge, extending above the top surface, and extending below the bottom surface; a front board coupled to the support board proximate the front edge and extending below the bottom surface; a rear board coupled to the support board proximate the rear edge and extending below the bottom surface; and a plurality of caster wheels coupled to the support board and extending downwardly from the bottom surface.

Yet another aspect of the present invention concerns a physical therapy method comprising the steps of: (a) positioning a scooter on a substantially horizontal surface; (b) causing a patient to lie over the scooter in a crawling position so that the patient's torso is at least partially supported by the scooter and the patients arms and legs are touching the horizontal surface on opposite sides of the scooter; and (c) while the patient is at least partially supported on the scooter, encouraging the patient to use the patient's arms and/or legs to locomote. The scooter includes a plurality wheels and a safety skirt. The safety skirt is disposed along-side at least a portion of the wheels to thereby prevent the patients hands from engaging the wheels during step (c).

### BRIEF DESCRIPTION OF THE DRAWING FIGURES

Various embodiments of the present invention are described in detail below with reference to the attached drawing figures wherein:

FIG. 1 is an isometric view of a patient supported in a crawling position on a physical therapy scooter constructed in accordance with an embodiment of the present invention;

FIG. 2 is an isometric view of the physical therapy scooter, with the caster wheel being shown in phantom;

FIG. 3 is a sectional view of the physical therapy scooter, with the section being cut width-wise through the scooter;

FIG. 4 is a section view of the physical therapy scooter cut along line 4-4 in FIG. 3; and

FIG. 5 is an isometric view of a physical therapy scooter constructed in accordance with an alternative embodiment of the present invention, particularly illustrating the scooter's tapered sides and integrally formed handle.

### DETAILED DESCRIPTION OF THE INVENTIVE EMBODIMENTS

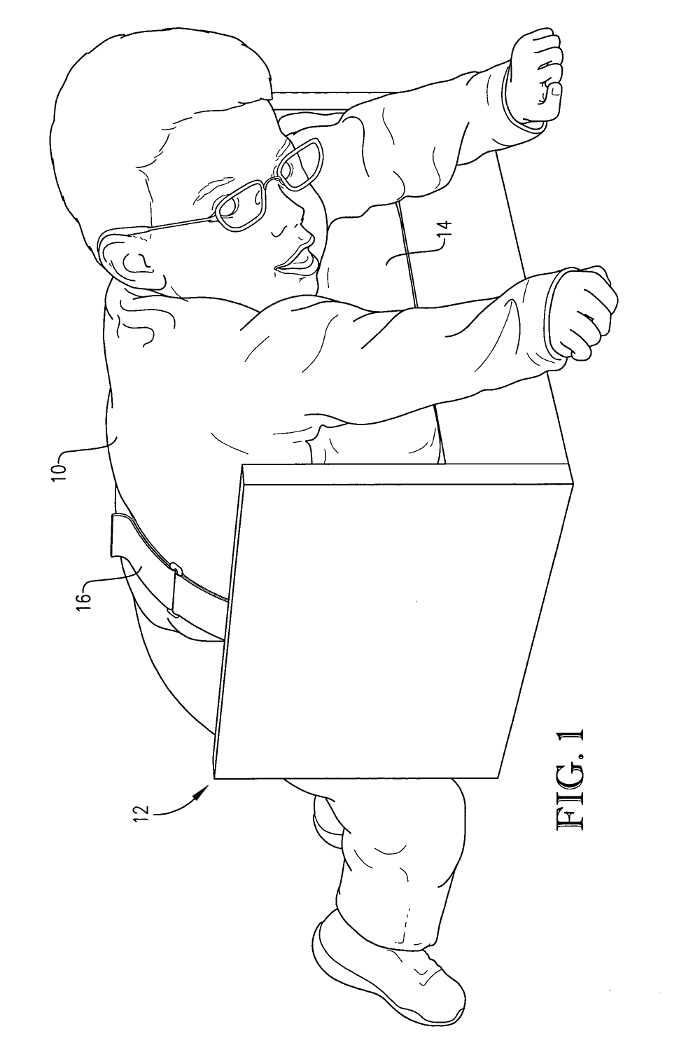

Referring initially to FIG. 1, a patient 10 is illustrated as being supported in a crawling position on a physical therapy scooter 12. The scooter 12 includes a cushion 14 upon which the torso of the patient 10 rests, while the arms and legs of the patient 10 are permitted to extend downwardly towards the floor on opposite sides of the scooter 12. The scooter 12 also includes an adjustable strap 16 to ensure that the patient does not fall or slide off of the scooter 12. When supported by the scooter 12 in the illustrated crawling position, a patient 10 with limited strength or motor development can independently move about (i.e., locomote) on the floor 16. This independent locomotion of the patient 10 promotes muscular and motor development. When the patient 10 is supported on the scooter 12, it may be necessary (especially for younger patients) to encourage the patient to try and move about on the scooter 12. One way to encourage younger children to independently locomote is to place a toy just out of reach of the patient 10. When the patient 10 moves to pick up the toy, the arm, legs, and neck of the patient 10 are exercised and strengthened. When the patient reaches the toy, hand-eye coordination is enhanced as the patient 10 manipulates and/or picks up the toy.

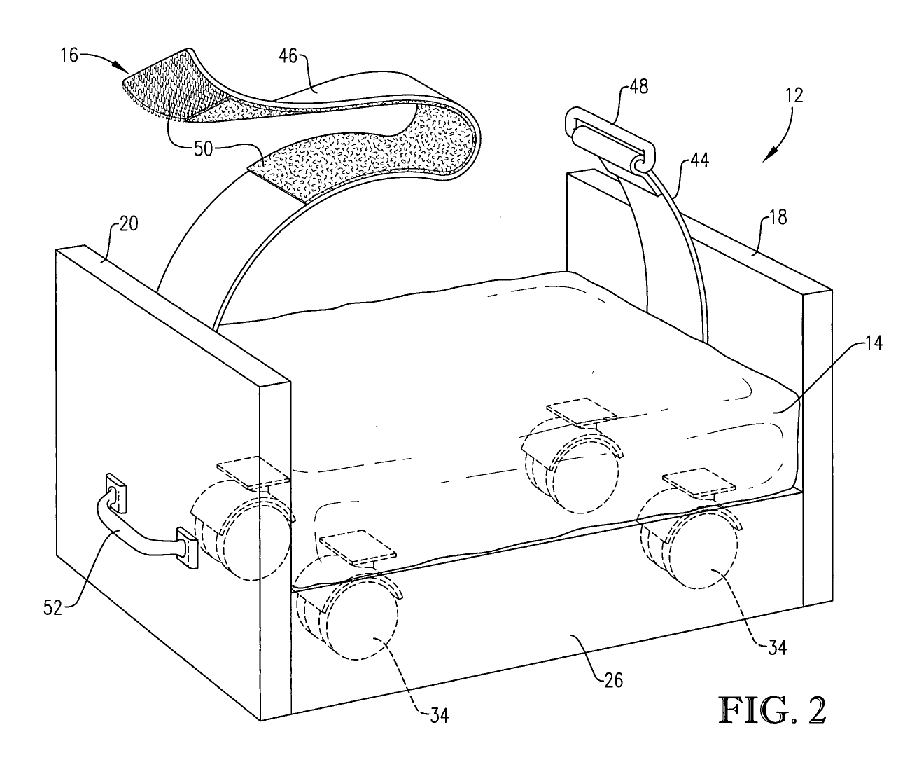

Referring now to FIGS. 2-4, the configuration of the scooter 12 will now be described in greater detail. The main body of the scooter 12 is formed of five substantially planar members: a right side member 18, a left side member 20, a lateral support member 22, a front member 24, and a rear member 26. The members 18-26 can be conventional wooden boards having a thickness of about 0.25 to about 1 inch, more preferably a thickness of 0.5 to 0.75 inch. The main body of scooter 12 can be assembled by attaching the members 18-26 to one another in the illustrated configuration using any convention means for permanently securing boards to one another such as, for example, screws, nails, glue, etc.

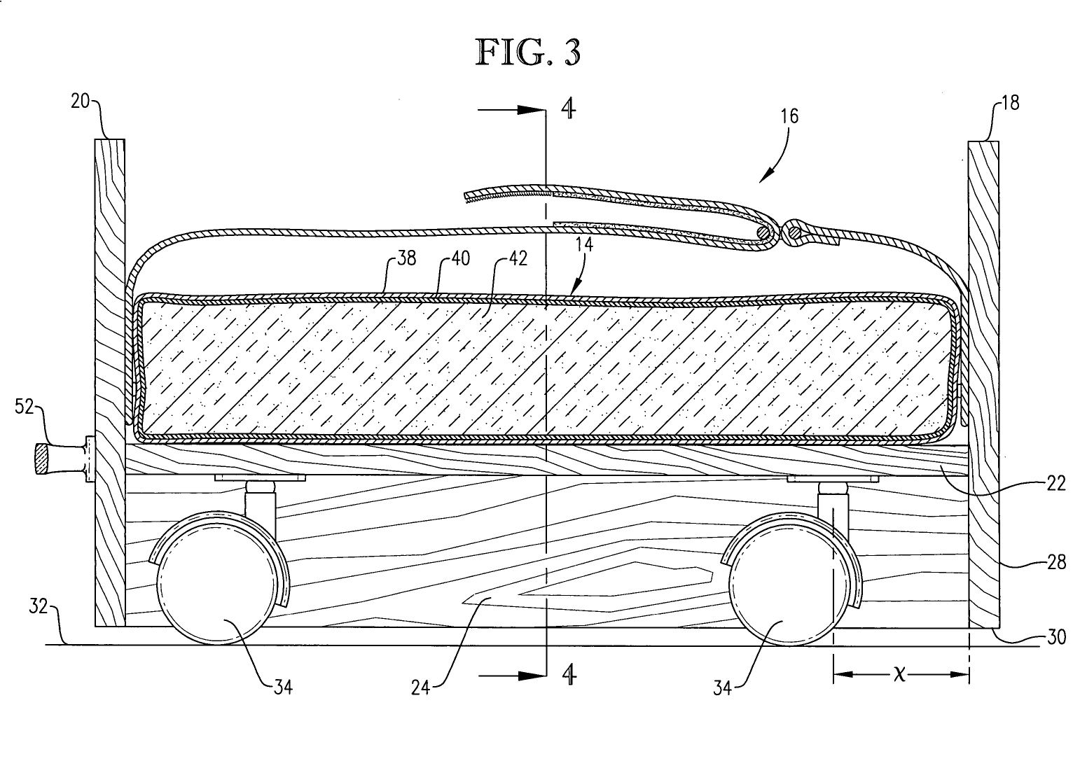

As perhaps best illustrated in FIG. 3, it is preferred for the right and left side members 18,20 to be substantially upright and laterally spaced from one another, with the lateral support member 22 extending substantially horizontally between side members 18,20. As shown in FIG. 3, the right side, left side, and lateral support members 18,20,22 form a generally H-shaped configuration, with the side members 18,20 being the legs of the “H” and the lateral support member 22 being the cross member of the “H”. Preferably, the upper portion of the right and left side members 18,20 extend at least about 1 inch above the top surface of the lateral support member 22, more preferably at least 2 inches above the top surface of the lateral support member 22.

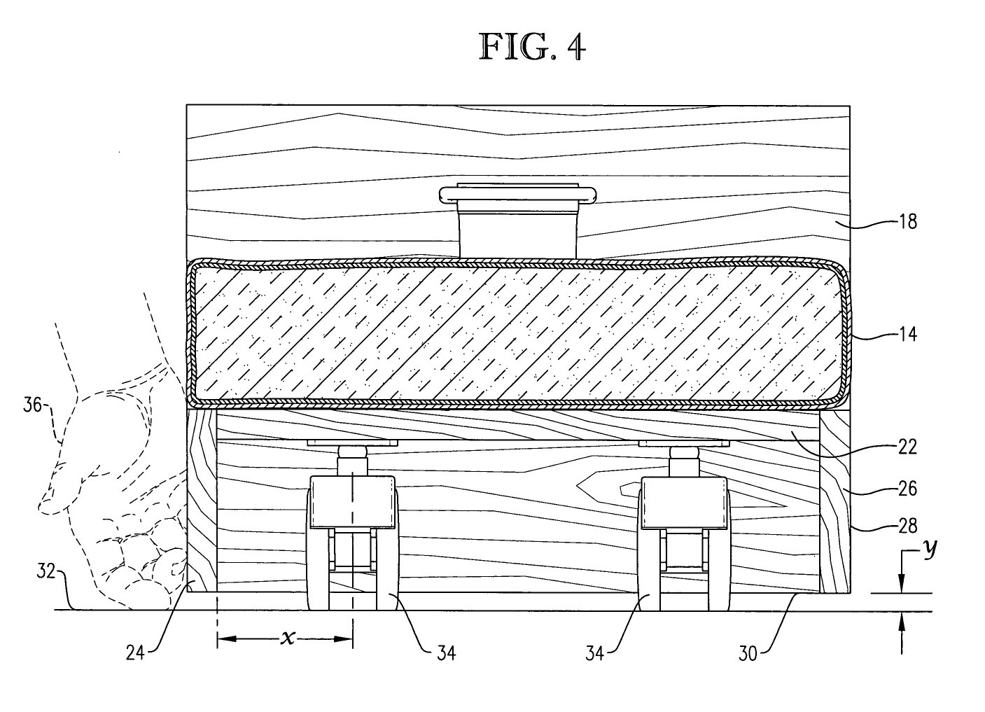

As perhaps best illustrated in FIG. 4, the front and rear members 24,26 are attached to opposite edges of the lateral support member 22 and extend between the ends of the right and left side members 18,20. The front and rear members 24,26 extend below the lateral support member 22 and cooperate with the bottom portion of the right and left side members for form a safety skirt 28 around the lower perimeter of the scooter 12. The bottom of the safety skirt 28 defines a generally planar lower terminal edge 30 that extends parallel to the floor 32.

Referring again to FIGS. 2-4, the scooter 12 employs a plurality of wheels 34 (preferably four caster-type wheels) for supporting the scooter 12 on the floor 32. The wheels 34 are coupled to and extend downwardly from the bottom of the lateral support member 22. The wheels 34 extend slightly further down from the lateral support member 22 than does the safety skirt 28, so that the safety skirt does not contact the floor 32 when the scooter 12 is supported on the floor 32 by the wheels 34. However, as shown in FIG. 4, it is preferred for the gap (labeled with dimension “y” in FIG. 4) formed between the lower terminal edge 30 of safety skirt 28 and the floor 32 to be minimized so that the safety skirt 28 substantially inhibits external lateral access (such as from a hand 36) to the wheels 34. Preferably, dimension “y” in FIG. 4 is less than the radius of the wheels 34, more preferably less than about 2 inches, still more preferably less than about 1 inch, and most preferably between 0.25 and 1 inch. Thus, the safety skirt 28 extends along side and circumscribes the wheels 34 so that the hand 36 of the patient 10 can not come into contact with and be pinched by the wheels 34.

Referring to FIG. 3 and 4, in order to maximize the stability of the scooter 12, it is preferred for the wheels 34 to be set outwardly toward the corners of the rectangular internal chamber defined within the safety skirt 28 and below the lateral support member 22. Thus, it is preferred for the minimum lateral distance (labeled with dimension “x” in FIGS. 3 and 4) between the safety skirt 28 and the vertical swivel axis of the nearest caster wheel 34 to be less than about 4 inches, more preferably less than about 3 inches, and most preferably less than 2 inches.

Referring to FIGS. 2 and 3, the cushion 14 of the scooter 12 is supported on the top surface of the lateral support member 22. The cushion 14 is preferably snugly received between the right and left side members 18,20 in a manner that frictionally restrains shifting of the cushion 12 relative to the lateral support member 22. If desired, the cushion 14 can be removably secured to the lateral support member 22 and/or the side members 18,20 via any conventional means such as, for example hook-and-loop fasteners (i.e., Velcro™). As shown in FIG. 3, the cushion 14 includes an outer removable cover 38, an inner permanent cover 40, and a filler material 42. The outer cover 38 can include an opening through which the inner cover 40 and filler material 42 and be removed and re-inserted. This allows the outer cover 38 to be easily removed and washed as needed. The opening in the outer cover 38 can be equipped with a zipper or other conventional closure mechanism to prevent unwanted removal of the outer cover 38 from the rest of the cushion 14. The inner cover 40 and filler material 42 can be formed of any suitable materials known in the art. As shown in FIG. 3, it is preferred for the side members 18,20 to extend above the cushion 14; however, in one embodiment of the present invention, the upper terminal edge of the side members 18,20 are truncated so as to be substantially flush with the top surface of the cushion 14.

Referring again to FIGS. 2 and 3, the adjustable strap 16 generally includes a fixed portion 44, an adjustable portion 46 and a loop 48. One end of the fixed portion 44 is coupled to the right side member 18 while the opposite end of the fixed portion 44 is coupled to the loop 48. One end of the adjustable portion 46 is coupled to the left side member 20, while the opposite end of the adjustable portion 46 is equipped with a hook-and-loop type fastener 50. Referring to FIGS. 1 and 2, when the patient 10 is support on the scooter 12, the adjustable strap 16 can be used to hold the patient 10 on the scooter 12 by passing the adjustable portion 46 of the strap 16 through the loop 48, pulling the adjustable portion 46 snugly, folding the adjustable portion 46 back on itself, and fastening the hook-and-loop fastener 50. To release the patient 10 from the scooter 12, these steps can be reversed. Thus, the adjustable strap 16 allows the scooter 12 to be used by patients of varying ages and sizes. As shown in FIGS. 2 and 3, the scooter 12 can also include a handle 52 for carrying the scooter 12 when it is not in use. It should be noted, that the compact rectangular configuration of the scooter 12 provides for easy transportation and storage. It should also be noted that the scooter 12 can be easily constructed with varying dimensions (i.e., scaled-up or scaled-down) to accommodate different sized patients.

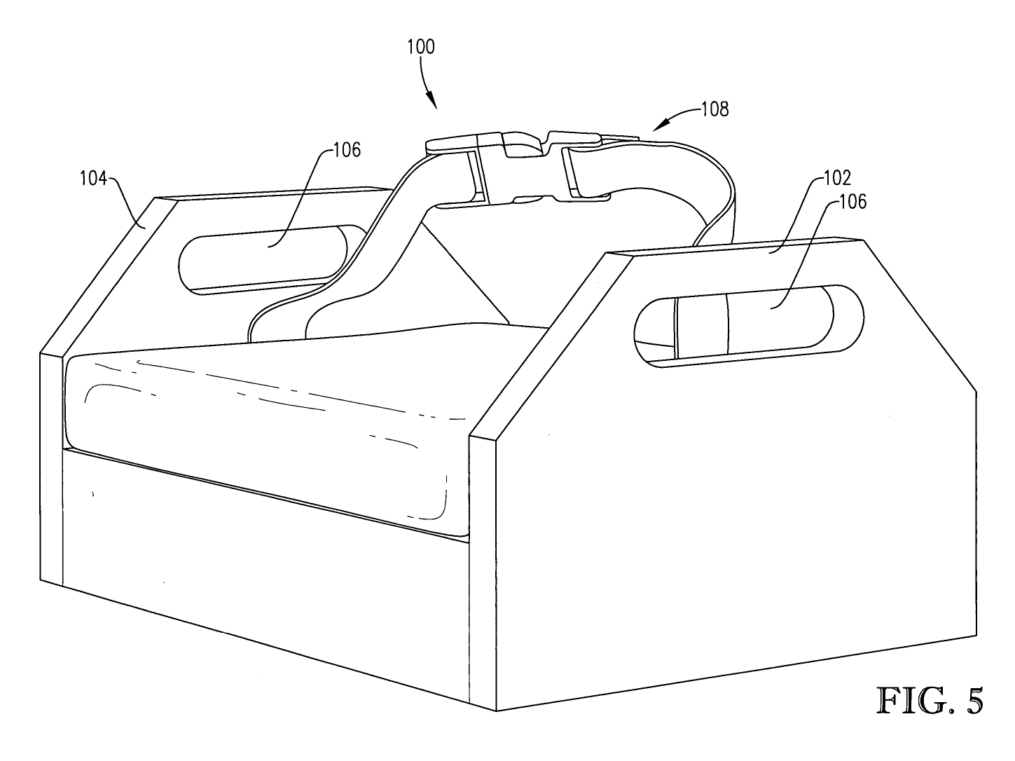

Referring now to FIG. 5, an alternative scooter design 100 is illustrated. The alternative scooter 100 is substantially similar to the scooter describe above with reference to FIGS. 1-4; however, the alternative scooter 100 includes right and left side member 102 that do not include 90 degree upper corners. Rather, the right and left side members 102 of alternative scooter 100 are cut down to prevent the presence of sharp 90 degree corners. Further, the right and left side members 102 of the alternative scooter 100 include integrally formed handle openings 106. Finally, the alternative scooter 100 includes a differently designed adjustable strap 108 which utilizes a buckle, rather than a hook-and-loop fastener, to secure the strap 108 around the patient.

The preferred forms of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventor hereby states his intent to rely on the Doctrine of Equivalents to determine and assess the reasonably fair scope of the present invention as it pertains to any apparatus not materially departing from but outside the literal scope of the invention as set forth in the following claims.

1. A scooter for use in physical therapy, said scooter comprising:
a laterally extending support member;
a pair of laterally spaced side members extending upwardly from the support member;
a plurality of caster wheels extending downwardly from the support member; and
a safety skirt extending downwardly from the lateral support member,
said safety skirt extending alongside at least a portion of the wheels to thereby inhibit external lateral access to the wheels.

2. The scooter according to claim 1; and
a cushion supported on the support member and extending between the side members.

3. The scooter according to claim 1,
said side members forming at least a portion of the safety skirt.

4. The scooter according to claim 1,
said support member and said side supports forming a generally H-shaped configuration, with the support member extending between the side members.

5. The scooter according to claim 1,
said support member presenting a substantially planar top surface,
said side members extending at least 2 inches above the top surface.

6. The scooter according to claim 1,
said support member presenting a substantially planar bottom surface,
said wheels extending a first distance below the bottom surface,
said safety skirt extending a second distance below the bottom surface,
said first distance being greater than the second distance so that a clearance distance is defined by the difference between the first and second distances,
said clearance distance being less than about 2 inches.

7. The scooter according to claim 6,
said clearance distance being less the radius of the wheels.

8. The scooter according to claim 1,
said safety skirt circumscribing all of the wheels,
said safety skirt presenting a substantially planar lower edge,
said lower edge extending along a plane that is co-planar with the bottom surface of the support member.

9. (canceled)

10. The scooter according to claim 1,
each of said caster wheels defining a vertical swivel axis that is laterally spaced from the skirt by a minimum distance that is less than about 3 inches.

11. A physical therapy scooter configured to help support and locomote a patient in a crawling position on a floor, said scooter comprising:
a substantially planar, normally-horizontal support member presenting a top surface and a bottom surface;
a pair of laterally spaced side members extending upwardly from opposite sides of the support member, said side members extending at least 2 inches above the top surface of the support member;
a cushion disposed on the top surface of the support member and between the side members and;
a plurality of caster wheels coupled to and extending downwardly from the bottom surface of the support member; and
a safety skirt coupled to the support member and extending below the bottom surface, said safety skirt extending alongside and substantially around the caster wheels to thereby inhibit external lateral access to the caster wheels when the scooter is supported by the wheels on the floor.

12. The scooter according to claim 11,
said side members forming a portion of the safety skirt.

13. The scooter according to claim 11,
said safety skirt presenting a lower terminal edge extending generally along a plane that is spaced from the floor by less than 1 inch when the scooter support by the wheels on the floor.

14. The scooter according to claim 11,
said support member being generally rectangular,
said safety skirt cooperating with the bottom surface of the support member to define a generally box-shaped chamber below the support member,
said plurality of caster wheels being substantially received in the box-shaped chamber.

15. The scooter according to claim 14,
said plurality of caster wheels comprising four caster wheels each positioned proximate a respective corner of the box-shaped chamber,
each of said caster wheels defining a swivel axis that is laterally spaced from the safety skirt by a minimum distance that is less than 2 inches.

16. A physical therapy scooter configured to help support and locomote a patient in a crawling position on a floor, said scooter comprising:
a substantially rectangular, substantially planar support board presenting a top surface, a bottom surface, a left edge, a right edge, a front edge, and a rear edge;
a left board coupled to the left edge, extending above the top surface, and extending below the bottom surface;
a right side board coupled to the right edge, extending above the top surface, and extending below the bottom surface;
a front board coupled to the support board proximate the front edge and extending below the bottom surface;
a rear board coupled to the support board proximate the rear edge and extending below the bottom surface; and
a plurality of caster wheels coupled to the support board and extending downwardly from the bottom surface.

17. The scooter of claim 16,
said left, right, front, and rear boards cooperatively forming a safety skirt that extends below the bottom surface of the support board,
said safety skirt circumscribing the caster wheels.

18. The scooter of claim 17,
said bottom surface cooperating with the safety shirt to define an internal chamber,
said internal chamber presenting an open end spaced from the bottom surface,
said caster wheels being substantially disposed in the chamber,
said caster wheels extending partly out of the chamber through the open end.

19. The scooter of claim 18,
said caster wheels extending less than 1 inch out of the chamber.

20. The scooter of claim 16; and
a generally rectangular cushion supported on the top surface of the support board and extending between the right and left boards.

21. A physical therapy method comprising the steps of:
(a) positioning a scooter on a substantially horizontal surface;
(b) causing a patient to lie over the scooter in a crawling position so that the patient's torso is at least partially supported by the scooter and the patients arms and legs are touching the horizontal surface on opposite sides of the scooter; and
(c) while the patient is at least partially supported on the scooter, encouraging the patient to use the patient's arms and/or legs to locomote,
said scooter comprising a plurality wheels and a safety skirt,
said safety skirt being disposed along-side at least a portion of the wheels to thereby prevent the patients hands from engaging the wheels during step (c).

22. The physical therapy method according to claim 21,
said safety skirt being spaced less than 1 inch from the substantially horizontal surface when the scooter is positioned on the horizontal surface with the wheels engaging the horizontal surface,
each of said wheels defining a vertical swivel axis that is spaced from the safety skirt by a minimum distance that is less than about 3 inches.

23. The physical therapy method according to claim 21,
said safety skirt being spaced less than 0.5 inches from the substantially horizontal surface when the scooter is positioned on the horizontal surface with the wheels engaging the horizontal surface,
each of said wheels defining a vertical swivel axis that is spaced from the safety skirt by a minimum distance that is less than 2 inches.

24. The physical therapy method according to claim 21,
said safety skirt extending substantially around the wheels.

25. The physical therapy method according to claim 21,
said scooter further comprising a laterally extending support member and a pair of laterally spaced side members,
said side members extending upwardly from the support member,
said plurality of wheels extending downwardly from the support member,
step (b) including causing the patient to lie over the scooter so that the patient's torso is supported on the support member and between the side members.

26. The physical therapy method according to claim 25,
said support member and said side supports forming a generally H-shaped configuration, with the support member extending between the side members.

27. The physical therapy method according to claim 25,
said side members forming at least a portion of the safety skirt.

28. The physical therapy method according to claim 25,
said support member presenting a substantially planar top surface,
said side members extending at least 2 inches above the top surface.

29. The physical therapy method according to claim 25,
said scooter further comprising a cushion supported on the support member and extending between the side members,
step (b) including causing the patient to lie over the scooter so that the patient's torso is supported on the cushion.

30. The physical therapy method according to claim 21,
said wheels being caster wheels.

31. The scooter according to claim 3,
each of said side members being formed at least partly of a single substantially rigid and substantially planar structural element extending above and below the support member.
